(19) United States
(12) Patent Application Publication
(10) Pub. No.: US 2013/0002684 A1
(43) Pub. Date: Jan. 3, 2013

(54) METHODS AND APPARATUS TO DRAW ANIMATIONS

(76) Inventor: Dale Paas, Kitchener (CA)

(21) Appl. No.: 13/634,832

(22) PCT Filed: Jul. 13, 2011
(86) PCT No.: PCT/CA11/50432

§ 371 Date: Sep. 13, 2012

Related U.S. Application Data
(60) Provisional application No. 61/364,382, filed on Jul. 14, 2010.

(51) Int. Cl. G06T 13/00

(52) U.S. Cl. 345/473

(57) ABSTRACT

Methods and apparatus to draw animations are disclosed. An example method includes writing a first frame of information into a first buffer, writing a second frame of information into a second buffer, displaying the first frame of information, displaying the second frame of information, and updating the first buffer using a difference between the first frame of information and a third frame of information.

### RELATED APPLICATIONS

This patent arises from and claims priority to U.S. Provisional Application Ser. No. 61/364,382, which was filed on Jul. 14, 2010, and is hereby incorporated herein by reference in its entirety.

### BACKGROUND

Animation of digital images is performed by displaying sequences of still digital images in succession. Animation is used by some presentation applications to sequence between presentation slides in a visually appealing manner.

### BRIEF DESCRIPTION OF THE DRAWINGS

For a better understanding of the various example embodiments described herein, and to show more clearly how they may be carried into effect, reference will now be made, by way of example only, to the accompanying drawings that show at least one example embodiment and in which:

FIG. 1 is a block diagram of an example presentation system showing a presentation and an animation within the presentation;

FIG. 2 is a block diagram of an example of a source device of FIG. 1, which may be implemented as a mobile device;

FIG. 3 is a block diagram of an example presenter of FIG. 1;

FIG. 4 is a block diagram of an example of a slide processor of FIG. 3;

FIG. 5 is a block diagram of an example slide drawer of FIG. 3;

FIG. 6 is a flow diagram of an example presentation method that may be implemented using machine readable instructions stored on tangible media;

FIG. 7 is a flow diagram of an example drawing time update method that may be implemented using machine readable instructions stored on tangible media;

FIG. 8 is a flow diagram of an example method for performing an estimate of the drawing time of a frame may be implemented using machine readable instructions stored on tangible media;

FIG. 9 is a flow diagram of an example build frame method that may be implemented using machine readable instructions stored on tangible media; and

FIG. 10 is an example diagram illustrating how the example build frame method of FIG. 9 operates.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments and examples described herein may be practiced without these specific details. In other instances, well-known methods, procedures and components have not been described in detail so as not to obscure the embodiments and examples described herein. Also, the description is not to be considered as limiting the scope of the embodiments and examples described herein.

The examples described herein generally relate to animation and, more particularly, example techniques to smooth the visual presentation of animations and example techniques to speed the building of animations to be displayed.

Animation frames have different sizes, and large frame sizes require more time to draw than small frame sizes. An assumed frame rate of 20 frames per second has been used in the past, which provides 50 milliseconds (ms) of draw time for a second frame while a first frame is being displayed. However, drawing large frames may exceed an assumed frame draw time (e.g. 50 ms) and may result in temporally uneven frame presentation and correspondingly degraded user experience. For example, if a second frame is a large frame in a frame set and the second frame takes 150 ms to draw, the presentation of a first frame preceding the second frame will be lengthened beyond 50 ms because the second frame is not ready to be displayed at the end of the 50 ms presentation of the first frame.

As described in conjunction with the examples described below, one manner in which to smooth frame presentation times of frames in a frame set is to evaluate each frame in a frame set to determine estimates regarding how long each frame will take to draw. If, in one example, the average of the estimates exceeds a threshold, each frame presentation is slowed (i.e., the draw time is lengthened) from the assumed frame draw time to the average draw time of the frame set. Alternatively, if the average frame draw time exceeds the assumed frame draw time, the assumed frame draw time may be changed to the longest draw time of a frame in the frame set.

To speed a rate at which animations are drawn or built, example techniques described herein utilize several buffers to prepare animation frames for presentation. In one example, two buffers may be used: one buffer for visible, on-screen information and one buffer for off-screen information. When a frame of information in the off-screen buffer is not being presented on the display because it has already been presented, the frame in the off-screen buffer may be updated with information representative of changes from the previously-displayed to make a next or subsequent frame for display. In one example, the updates may be carried out between consecutive frames (e.g., updates to frame one to make frame two may be applied to frame one). Alternatively, the updates may be carried out between non-consecutive frames (e.g., updates to frame one to make frame three may be applied to frame one).

In another example, an odd buffer and an even buffer may be maintained in addition to a display buffer. In this manner the odd buffer may be used to apply differences between odd frames to make a next odd frame for display (e.g., frame three can be made by applying updates to frame one, and, subsequently, frame five may be made by applying updates to frame three, etc.). Similarly, the even buffer may be used to apply differences between even frames to make a next even frame (e.g., frame four can be made by applying updates to frame two, and, subsequently, frame six may be made by applying updates to frame four, etc.).

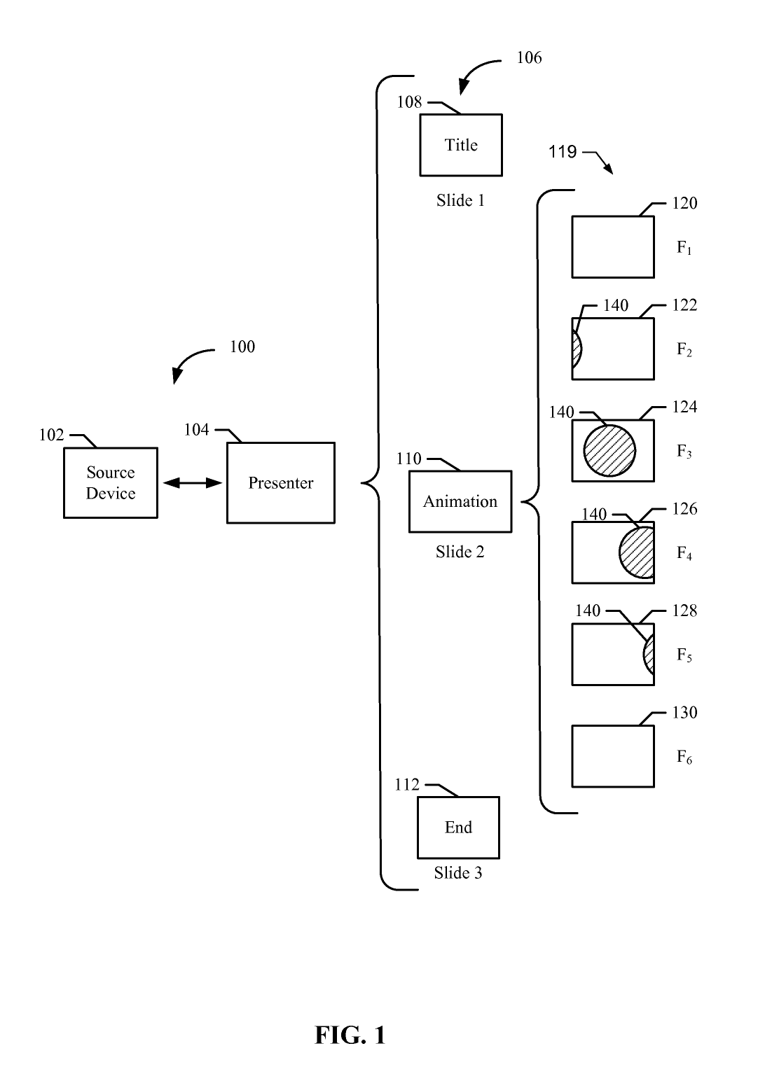

Referring to FIG. 1, a presentation system 100 includes a source device 102 that provides information to a presenter 104. In one example, the information provided by the source device 102 is information representative of one or more presentations, which may include slides that may or may not include animations, etc. For example, the presentations may be authored using PowerPoint® presentation graphics program, or any other suitable presentation authoring software. The information provided from the source device 102 may also include one or more user inputs, such as traversal commands, that a user provides to control the visual flow of the presentation via the source device 102.

The presenter 104 processes the information provided by the source device 102 and outputs a presentation 106 to a device on which the presentation may be viewed. For example, the presenter 104 may output the presentation to a computer monitor, a television display, a projector, or any other suitable device upon which the presentation 106 may be viewed.

As shown in FIG. 1, in one example the presentation 106 includes a title slide 108, an animation slide 110, and an end slide 112. The title slide 108 and the end slide 112 may include only fixed graphical information, such as text, pictures, etc. However, the animation slide 110 may include animation presented in a set of frames. The animation slide 110 may then include a frame set 119 including six frames of animation 120, 122, 124, 126, 128, 130. In the example of FIG. 1, the frames show a circle 140 that traverses from left to right on the frames as the frames progress from frame 1 120 to frame 6 130. Because the six frames of animation have different amounts of graphical information (e.g., frame 1 120 includes no graphics and frame 3 124 includes a full graphic of the circle 140), the frames will require different amounts of time for the graphics of the frames to be drawn. These differing amounts of draw time can result in irregular frame presentation times. However, as described below, the examples described herein can evaluate these different draw times and smooth the frame presentation times.

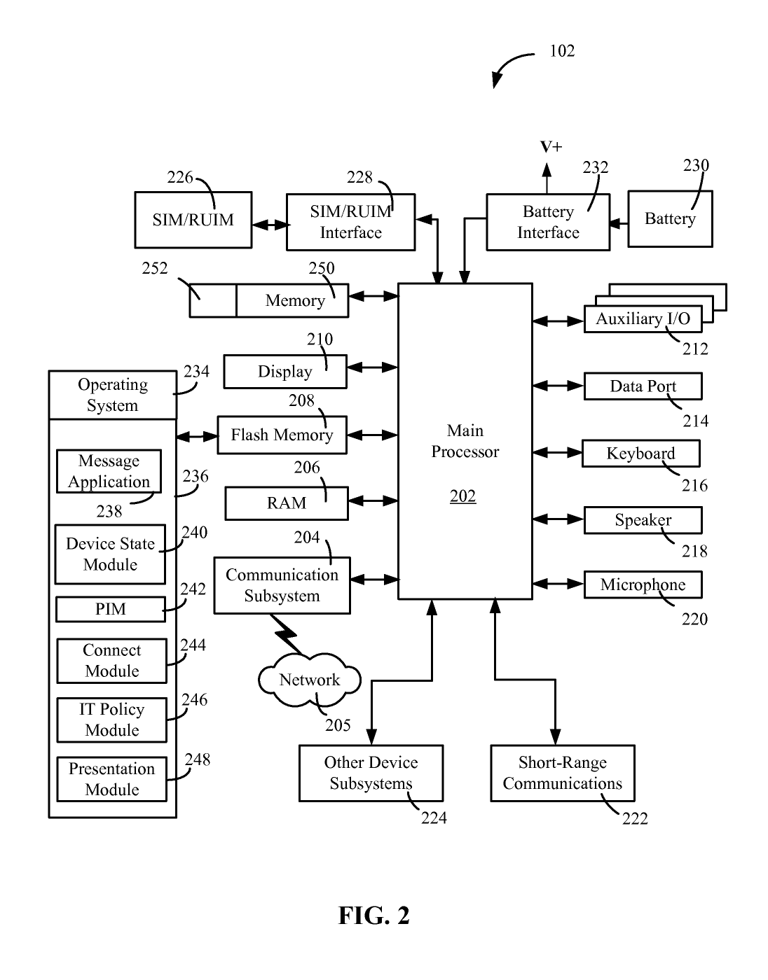

FIG. 2 is a block diagram of one example source device 102, as shown in FIG. 1. In the example, of FIG. 2, the source device 102 is a mobile device including a number of components such as a main processor 202 that controls the overall operation of the source device 102. Communication functions, including data and voice communications, are performed through a communication subsystem 204. The communication subsystem 204 receives messages from and sends messages to a wireless network 205. In this example of the source device 102, the communication subsystem 204 is configured in accordance with the Global System for Mobile Communication (GSM) and General Packet Radio Services (GPRS) standards. The GSM/GPRS wireless network is used worldwide and it is expected that these standards will be superseded eventually by Enhanced Data GSM Environment (EDGE) and Universal Mobile Telecommunications Service (UMTS). New standards are still being defined, but it is believed that they will have similarities to the network behavior described herein, and it will also be understood by persons skilled in the art that the examples described herein are intended to use any other suitable standards that are developed in the future. The wireless link connecting the communication subsystem 204 with the wireless network 205 represents one or more different Radio Frequency (RF) channels, operating according to defined protocols specified for GSM/GPRS communications. With newer network protocols, these channels are capable of supporting both circuit switched voice communications and packet switched data communications.

Although the wireless network 205 associated with source device 102 is a GSM/GPRS wireless network in one example implementation, other wireless networks may also be associated with the source device 102 in variant implementations. The different types of wireless networks that may be employed include, for example, data-centric wireless networks, voice-centric wireless networks, and dual-mode networks that can support both voice and data communications over the same physical base stations. Combined dual-mode networks include, but are not limited to, Code Division Multiple Access (CDMA) or CDMA2000 networks, GSM/GPRS networks (as mentioned above), and future third-generation (3G) networks like EDGE and UMTS. Some other examples of data-centric networks include WiFi 802.11, Mobitex™ and DataTAC™ network communication systems. Examples of other voice-centric data networks include Personal Communication Systems (PCS) networks like GSM and Time Division Multiple Access (TDMA) systems.

The main processor 202 also interacts with additional subsystems such as a Random Access Memory (RAM) 206, a flash memory 208, a display 210, an auxiliary input/output (I/O) subsystem 212, a data port 214, a keyboard 216, a speaker 218, a microphone 220, short-range communications 222 and other device subsystems 224.

Some of the subsystems of the source device 102 perform communication-related functions, whereas other subsystems may provide “resident” or on-device functions. By way of example, the display 210 and the keyboard 216 may be used for both communication-related functions, such as entering a text message for transmission over the network 205, and device-resident functions such as a calculator or task list.

The source device 102 can send and receive communication signals over the wireless network 205 after required network registration or activation procedures have been completed. Network access is associated with a subscriber or user of the source device 102. To identify a subscriber, the source device 102 requires a SIM/RUIM card 126 (i.e. Subscriber Identity Module or a Removable User Identity Module) to be inserted into a SIM/RUIM interface 228 in order to communicate with a network. The SIM card or RUIM 226 is one type of a conventional “smart card” that can be used to identify a subscriber of the source device 102 and to personalize the source device 102, among other things. Without the SIM card 226, the source device 102 is not fully operational for communication with the wireless network 205. By inserting the SIM card/RUIM 226 into the SIM/RUIM interface 228, a subscriber can access all subscribed services. Services may include: web browsing and messaging such as e-mail, voice mail, Short Message Service (SMS), and Multimedia Messaging Services (MMS). More advanced services may include: point of sale, field service and sales force automation. The SIM card/RUIM 226 includes a processor and memory for storing information. Once the SIM card/RUIM 226 is inserted into the SIM/RUIM interface 228, it is coupled to the main processor 202. In order to identify the subscriber, the SIM card/RUIM 226 can include some user parameters such as an International Mobile Subscriber Identity (IMSI). An advantage of using the SIM card/RUIM 226 is that a subscriber is not necessarily bound by any single physical mobile device. The SIM card/RUIM 226 may store additional subscriber information for a mobile device as well, including datebook (or calendar) information and recent call information. Alternatively, user identification information can also be programmed into the flash memory 208.

The source device 102 is a battery-powered device and includes a battery interface 232 for receiving one or more rechargeable batteries 230. In at least some embodiments, the battery 230 can be a smart battery with an embedded microprocessor. The battery interface 232 is coupled to a regulator (not shown), which assists the battery 230 in providing power V+ to the source device 102. Although current technology makes use of a battery, future technologies such as micro fuel cells may provide the power to the source device 102.

The source device 102 also includes an operating system 234 and software components 236 to 248. The operating system 234 and the software components 236 to 248 that are executed by the main processor 202 are typically stored in a persistent store such as the flash memory 208, which may alternatively be a read-only memory (ROM) or similar storage element (not shown). Those skilled in the art will appreciate that portions of the operating system 234 and the software components 236 to 248, such as specific device applications, or parts thereof, may be temporarily loaded into a volatile store such as the RAM 206. Other software components can also be included, as is well known to those skilled in the art.

The subset of software applications 236 that control basic device operations, including data and voice communication applications, will normally be installed on the source device 102 during its manufacture. Other software applications include a message application 238 that can be any suitable software program that allows a user of the source device 102 to send and receive electronic messages. Various alternatives exist for the message application 238 as is well known to those skilled in the art. Messages that have been sent or received by the user are typically stored in the flash memory 208 of the source device 102 or some other suitable storage element in the source device 102. In at least some embodiments, some of the sent and received messages may be stored remotely from the source device 102 such as in a data store of an associated host system that the source device 102 communicates with.

The software applications can further include a device state module 240, a Personal Information Manager (PIM) 242, and other suitable modules (not shown). The device state module 240 provides persistence, i.e. the device state module 240 ensures that important device data is stored in persistent memory, such as the flash memory 208, so that the data is not lost when the source device 102 is turned off or loses power.

The PIM 242 includes functionality for organizing and managing data items of interest to the user, such as, but not limited to, e-mail, contacts, calendar events, voice mails, appointments, and task items. A PIM application has the ability to send and receive data items via the wireless network 205. PIM data items may be seamlessly integrated, synchronized, and updated via the wireless network 205 with the mobile device subscriber's corresponding data items stored and/or associated with a host computer system. This functionality creates a mirrored host computer on the source device 102 with respect to such items. This can be particularly advantageous when the host computer system is the mobile device subscriber's office computer system.

The source device 102 also includes a connect module 244, and an IT policy module 246. The connect module 244 implements the communication protocols that are required for the source device 102 to communicate with the wireless infrastructure and any host system, such as an enterprise system with which the source device 102 is authorized to interface.

The connect module 244 includes a set of APIs that can be integrated with the source device 102 to allow the source device 102 to use any number of services associated with the enterprise system. The connect module 244 allows the source device 102 to establish an end-to-end secure, authenticated communication pipe with the host system. A subset of applications for which access is provided by the connect module 244 can be used to pass IT policy commands from the host system to the source device 102. This can be done in a wireless or wired manner. These instructions can then be passed to the IT policy module 246 to modify the configuration of the source device 102. Alternatively, in some cases, the IT policy update can also be done over a wired connection.

The IT policy module 246 receives IT policy data that encodes the IT policy. The IT policy module 246 then ensures that the IT policy data is authenticated by the source device 102. The IT policy data can then be stored in the flash memory 206 in its native form. After the IT policy data is stored, a global notification can be sent by the IT policy module 246 to all of the applications residing on the source device 102. Applications for which the IT policy may be applicable then respond by reading the IT policy data to look for IT policy rules that are applicable.

The IT policy module 246 can include a parser (not shown), which can be used by the applications to read the IT policy rules. In some cases, another module or application can provide the parser. Grouped IT policy rules, described in more detail below, are retrieved as byte streams, which are then sent (recursively, in a sense) into the parser to determine the values of each IT policy rule defined within the grouped IT policy rule. In at least some embodiments, the IT policy module 246 can determine which applications are affected by the IT policy data and send a notification to only those applications. In either of these cases, for applications that aren't running at the time of the notification, the applications can call the parser or the IT policy module 246 when they are executed to determine if there are any relevant IT policy rules in the newly received IT policy data.

All applications that support rules in the IT Policy are coded to know the type of data to expect. For example, the value that is set for the “WEP User Name” IT policy rule is known to be a string; therefore the value in the IT policy data that corresponds to this rule is interpreted as a string. As another example, the setting for the “Set Maximum Password Attempts” IT policy rule is known to be an integer, and therefore the value in the IT policy data that corresponds to this rule is interpreted as such.

After the IT policy rules have been applied to the applicable applications or configuration files, the IT policy module 246 sends an acknowledgement back to the host system to indicate that the IT policy data was received and successfully applied.

The source device 102 of the example of FIG. 2 also includes a presentation module 248, which may be used to author presentations or read files representative of stored presentations. In one example, the presentation module 248 may operate with the short-range communications subsystem 222 to provide presentation information such as slide information and traversal commands to the presenter 104. For example, a presentation, such as the presentation 106 of FIG. 1 may be stored within one of the memories of the source device 102 and accessed by the presentation module 248. The presentation module 248 may, in turn, provide the presentation 106 to the presenter 104 via the short-range communications module 222. As described herein, the presenter 104 may then process the presentation and display the same to one or more viewers.

Other types of software applications can also be installed on the source device 102. These software applications can be third party applications, which are added after the manufacture of the source device 102. Examples of third party applications include games, calculators, utilities, etc.

The additional applications can be loaded onto the source device 102 through at least one of the wireless network 205, the auxiliary I/O subsystem 212, the data port 214, the short-range communications subsystem 222, or any other suitable device subsystem 224. This flexibility in application installation increases the functionality of the source device 102 and may provide enhanced on-device functions, communication-related functions, or both. For example, secure communication applications may enable electronic commerce functions and other such financial transactions to be performed using the source device 102.

The data port 214 enables a subscriber to set preferences through an external device or software application and extends the capabilities of the source device 102 by providing for information or software downloads to the source device 102 other than through a wireless communication network. The alternate download path may, for example, be used to load an encryption key onto the source device 102 through a direct and thus reliable and trusted connection to provide secure device communication.

The data port 214 can be any suitable port that enables data communication between the source device 102 and another computing device. The data port 214 can be a serial or a parallel port. In some instances, the data port 214 can be a USB port that includes data lines for data transfer and a supply line that can provide a charging current to charge the battery 230 of the source device 102.

The short-range communications subsystem 222 provides for communication between the source device 102 and different systems or devices, without the use of the wireless network 205. For example, the subsystem 222 may include an infrared device and associated circuits and components for short-range communication. Examples of short-range communication standards include standards developed by the Infrared Data Association (IrDA), Bluetooth, and the 802.11 family of standards developed by IEEE.

In use, a received signal such as a text message, an e-mail message, or web page download will be processed by the communication subsystem 204 and input to the main processor 202. The main processor 202 will then process the received signal for output to the display 210 or alternatively to the auxiliary I/O subsystem 212. A subscriber may also compose data items, such as e-mail messages, for example, using the keyboard 216 in conjunction with the display 210 and possibly the auxiliary I/O subsystem 212. The auxiliary subsystem 212 may include devices such as: a touch screen, mouse, track ball, infrared fingerprint detector, or a roller wheel with dynamic button pressing capability. The keyboard 216 is preferably an alphanumeric keyboard and/or telephone-type keypad. However, other types of keyboards may also be used. A composed item may be transmitted over the wireless network 205 through the communication subsystem 204.

For voice communications, the overall operation of the source device 102 is substantially similar, except that the received signals are output to the speaker 218, and signals for transmission are generated by the microphone 220. Alternative voice or audio I/O subsystems, such as a voice message recording subsystem, can also be implemented on the source device 102. Although voice or audio signal output is accomplished primarily through the speaker 218, the display 210 can also be used to provide additional information such as the identity of a calling party, duration of a voice call, or other voice call related information.

The source device 102 also includes a memory 250, which may be part of the RAM 206, the flash memory 208 or may be a separate memory itself, includes a portion 252 in which machine readable instructions may be stored. For example, machine readable instructions the execution of which implements the methods described in conjunction with the flow diagrams described here may be stored in the memory portion 252 and executed by the main processor 202.

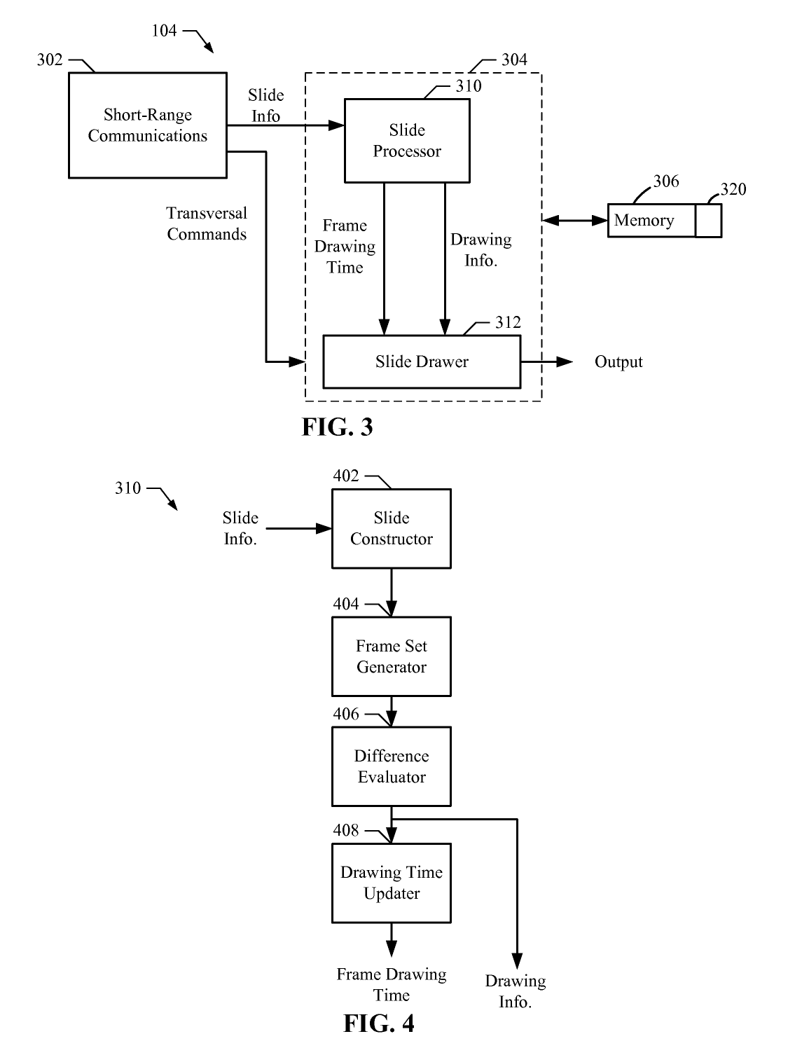

A block diagram of one example of the presenter 104 is shown FIG. 3. A short-range communications subsystem 302 is coupled to a processor 304, which is also coupled to a memory 306. Of course other functionality may be included in the presenter 104.

The short-range communications subsystem 302 is configured to exchange information with the short-range communications subsystem 222 of FIG. 2. For example, the short-range communications subsystem 302 may include an infrared device and associated circuits and components for short-range communication. The short-range communications subsystem 302 may be implemented according to standards developed by the Infrared Data Association (IrDA), Bluetooth, and the 802.11 family of standards developed by IEEE. The short-range communications subsystems 222 and 302 may be used to provide presentation information, such as slide information and traversal commands, from the source device 102 to the presenter 104.

The processor 304, which may be any logic device including data processors, digital signal processors, programmable logic, combinational logic, etc., implements a slide processor 310 and a slide drawer 312, details of each of which are provided below. The slide processor 310 and the slide drawer 312 may be implemented in a processor and/or may be implemented using any desired combination of hardware, firmware, and/or software. For example, one or more integrated circuits, discrete semiconductor components, and/or passive electronic components may be used. Thus, for example, the slide processor 310 and the slide drawer 312, or parts thereof, could be implemented using one or more circuit(s), programmable processor(s), application specific integrated circuit(s) (ASIC(s)), programmable logic device(s) (PLD(s)), field programmable logic device(s) (FPLD(s)), etc. The slide processor 310 and the slide drawer 312, or parts thereof, may be implemented using instructions, code, and/or other software and/or firmware, etc. stored on a machine accessible medium and executable by for example a processor (e.g. the example processor 304). When any of the appended apparatus claims are read to cover a purely software implementation, at least one of the slide processor 310 and the slide drawer 312 is hereby expressly defined to include a tangible medium such as a solid state memory, a magnetic memory, a DVD, a CD, etc.

The memory 306, which may be implemented using RAM, flash memory, ROM, or any combination thereof, includes a portion 320 in which machine readable instructions may be stored. For example, machine readable instructions, the execution of which implement the slide processor 310 and/or the slide drawer 312, or implement one or more of the methods described in conjunction with the flow diagrams described herein, may be stored in the memory portion 320 and executed by the processor 304.

In general, the presenter 104 may be based on a BlackBerry® Presenter platform. The BlackBerry Presenter is commercially available from Research In Motion Limited.

In operation, the presenter 104 receives slide information and traversal commands from the source device 102 through the short-range communication subsystem 302. Of course, the presenter 104 could receive the slide information and traversal commands through a hardwired connection, such as a universal serial bus (USB) connection or any other suitable connection.

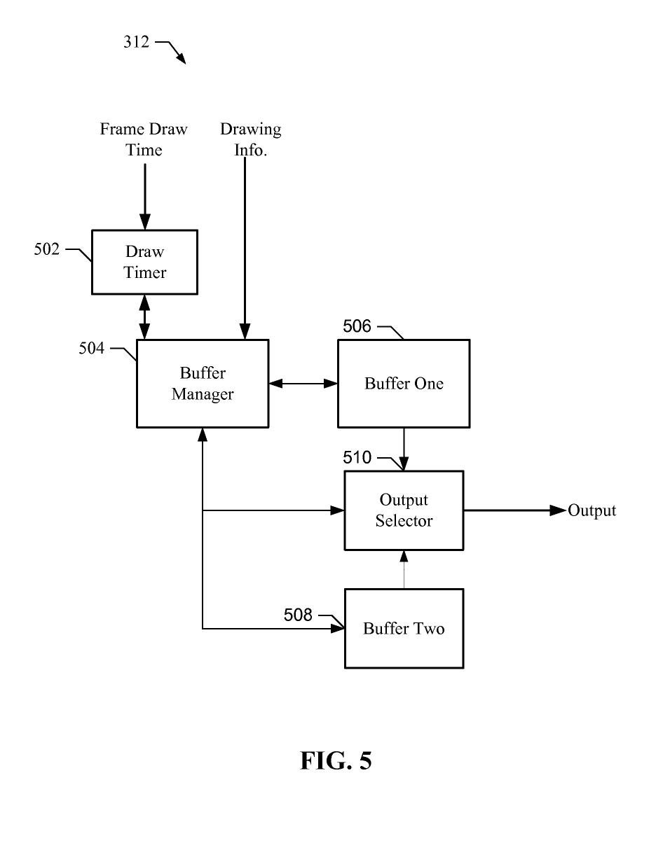

The slide information is passed to the slide processor 310, which processes one or more frames of animation, as described in the examples below, to determine a frame drawing time. The frame drawing time and the slide information passes to a slide drawer 312, which also receives the traversal commands and draws output graphics that are provided to a graphics system (not shown) for display. Further detail regarding each of the slide processor 310 and the slide drawer 312 is provided in conjunction with FIGS. 4 and 5 below.

As shown in FIG. 4, in one example the slide processor 310 includes a slide constructor 402, a frame set generator 404, a difference evaluator 406, and a drawing time updater 408. As described in conjunction with FIG. 3, each of the slide constructor 402, the frame set generator 404, the difference evaluator 406, and the drawing time updater 408 may be implemented using any number of different techniques and/or technologies.

In operation, the slide information is passed to the slide constructor 402. The slide constructor 402 gathers slide information and decompresses any images, such as, for example, the image or images representative of the circle 140 shown in FIG. 1. The slide constructor 402 determines if there is a slide for which animation is used. For example, with reference to FIG. 1, animation is present in slide two 110. The slide constructor 402 passes the frame information to the frame set generator 404, which generates a frame set corresponding to the animation and adds the images (e.g., the circles 140 of FIG. 1) to the frame set. For example, as described above, the frame set 119 may include the frames 120, 122, 124, 126, 128, 130 as shown in FIG. 1.

In one example, to reduce the amount of draw time needed to draw a frame, the difference evaluator 406 examines the differences between certain ones of the frames and develops a difference list. For example, the difference evaluator 406 may determine the difference between a first frame and its immediately following frame and may store the difference. In this manner, as described below, it will not be necessary to redraw and entire frame from scratch. Instead, the differences between the first frame and the second frame may be applied to the first frame to more quickly draw the second frame.

Although the foregoing describes the difference evaluator 406 as determining the differences between sequential frames, in other examples the differences may be evaluated between non-sequential frames. For example, the differences between sequential odd frames (e.g., frames one and three, frames three and five, frames five and seven, etc.) may be determined. Similarly, the differences between sequential even frames (e.g., frames two and four, frames four and six, frames six and eight, etc.) may be determined.

The drawing time updater 408 receives the drawing information, including the differences between frames (sequential and/or non-sequential), and estimates how long it will take to draw each frame of the frame set based on the drawing information. In one example, the estimates may be carried out by considering the images and drawing rectangles of each frame. In one example, a drawing time estimate for each image is based on whether the image is transparent and the size of the image. For example, for transparent regions, areas of less than 80,000 pixels are assumed to have a frame drawing time in milliseconds that is the pixel area divided by 4000 (e.g., an 80,000 pixel area has an estimated drawing time of 20 ms. Further, transparent regions having areas between 80,000 and 100,000 pixels are assumed to have a frame drawing time in milliseconds that is the pixel area divided by 5000, and transparent regions having areas between 100,000 and 180,000 pixels are assumed to have a frame drawing time in milliseconds that is the pixel area divided by 6000. When considering non-transparent images, the raw copy time is used more directly: 1024×768 pixels, takes 30 ms; less than 980,000 pixels and greater than 720,000 pixels takes 25 ms; and less than 720,000 pixels and greater than 500,000 pixels takes 20 ms.

Drawing time estimates for each rectangle of each image are summed to calculate a running total of the drawing time estimate for the frame. Thus, attributes for each frame may be used to determine a draw time estimate for each frame. For example, it may be determined that a frame having a significant amount of graphics (e.g., frame 124 of FIG. 1) may require 150 ms of drawing time, which is well above the assumed 50 ms of drawing time.

The estimated drawing time of each frame is added to the total estimated drawing time of the frame set (e.g., the frame set 119 of FIG. 1). After drawing times are determined for all the frames of the frame set, the total of these drawing estimate is divided by the number of frames for which the estimate was produced, which results in an average drawing time estimate for the frame set. The average drawing time estimate is compared to a threshold, which may, in one example be 50% longer than the assumed frame time. For example, if the assumed frame time is 50 ms, the threshold is 75 ms. If the average exceeds the threshold, the average is used as the draw time, which is passed to the slide drawer 312 (FIGS. 3 and 5). If, however, the average does not exceed the threshold, the assumed frame time may be used as the frame drawing time.

FIG. 5 illustrates one example of the slide drawer 312 (FIG. 3). The slide drawer 312 includes a draw timer 502 that is coupled to a buffer manager 504, which is further coupled to a first buffer called buffer one 506, and a second buffer called buffer two 508. An output selector 510 is coupled to each of buffer one 506 and buffer two 508, such that each of the buffers can be switched between an on-screen context during which its contents are displayed, and an off-screen context during which its contents are not displayed. While buffer one 506 and buffer two 508 are shown as separate buffers, these buffers may be replaced with a single buffer in some example implementations. As explained above in conjunction with FIG. 3, the draw timer 502 and the buffer manager 504 may be implemented using any combination of hardware, software, logic, etc. The buffers 506, 508 may be implemented using the memory 306, or any other suitable memory.

The draw timer 502 receives the frame draw time from the drawing time updater 408 (FIG. 4). The frame draw time is used by the buffer manager 504 to control the time for which each frame in a frame set having an animation is displayed. As described above, the frame draw time may be an assumed frame time (e.g., 50 ms) or, due to the nature of the frames of the animation, may be longer as determined by the drawing time updater 408 to smooth the temporal presentation of the animation.

The buffer manager 504 receives the drawing information from the slide processor 310 (FIGS. 3 and 4) and coordinates the use of one or more of the buffers 506, 508 to draw frames of information that are selected by the output selector 510 for presentation to a viewer, which makes the selected buffer the on-screen buffer and the unselected buffer the off-screen buffer. The buffer manager 504 also receives input from the draw timer 502 as a signal to change the frame that is presented to a viewer. In one example, the buffer manager 504 can control the designations of which of the buffers 506, 508 is the off-screen buffer and which is the on-screen buffer by controlling the output selector 510. Thus, when it is the off-screen buffer, buffer one 506 may be used to store a first frame that is updated with information to make a third frame while a second frame is currently displayed to the user by buffer two 508, which is the on-screen buffer. When the buffer manager 504 determines that it is time to display the third frame, the contexts of buffer one 506 and buffer two 508 are changed, so that the third frame is displayed. While the third frame is displayed, the buffer manager 504 updates the second frame located in the off-screen buffer to make a fourth frame that will later be displayed when the draw timer 502 expires.

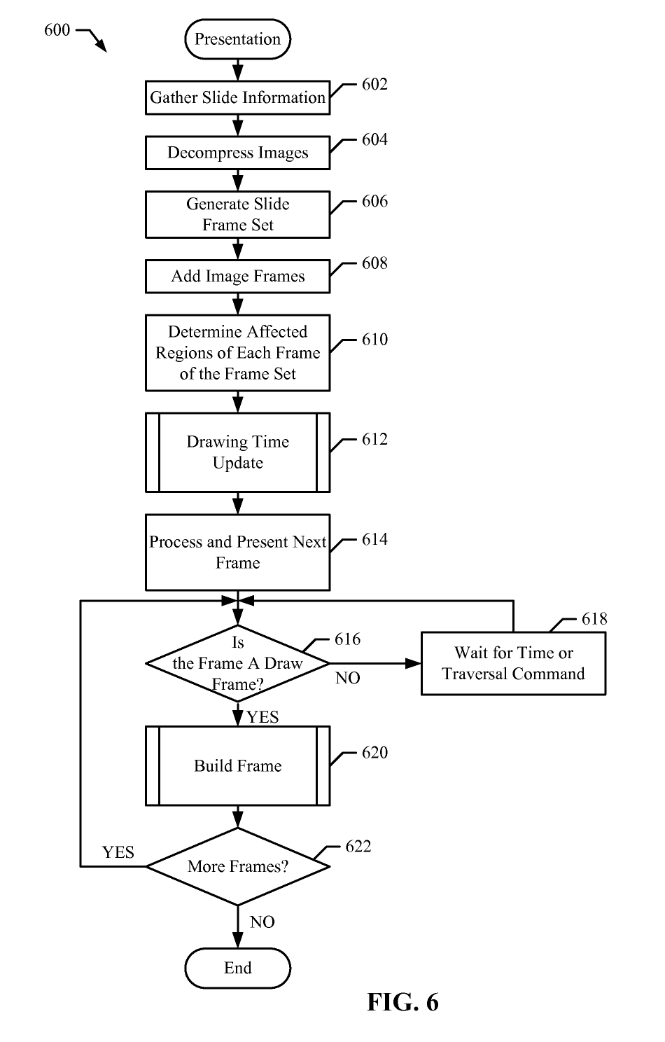

FIGS. 6-9 illustrate example flow diagrams representative of methods that may be implemented using, for example, computer readable instructions. The example methods of FIGS. 6-9 may be performed using one or more processors (e.g., the processor 304), controllers, and/or any other suitable processing devices. For example, the example methods of FIGS. 6-9 may be implemented using coded instructions (e.g., computer readable instructions) stored on one or more tangible computer readable media such as flash memory, read-only memory (ROM), and/or random-access memory (RAM). As used herein, the term tangible computer readable medium is expressly defined to include any type of computer readable storage and to exclude propagating signals. Additionally or alternatively, the example methods of FIGS. 6-9 may be implemented using coded instructions (e.g., computer readable instructions) stored on one or more non-transitory computer readable media such as flash memory, read-only memory (ROM), random-access memory (RAM), cache, or any other storage media in which information is stored for any duration (e.g., for extended time periods, permanently, brief instances, for temporarily buffering, and/or for caching of the information). As used herein, the term non-transitory computer readable medium is expressly defined to include any type of computer readable medium and to exclude propagating signals.

Alternatively, some or all of the example methods of FIGS. 6-9 may be implemented using any combination(s) of logic, such as application specific integrated circuit(s) (ASIC(s)), programmable logic device(s) (PLD(s)), field programmable logic device(s) (FPLD(s)), discrete logic, hardware, firmware, etc. Also, some or all of the example methods of FIGS. 6-9 may be implemented manually or as any combination(s) of any of the foregoing techniques, for example, any combination of firmware, software, discrete logic and/or hardware. Further, although the example methods of FIGS. 6-9 are described with reference to the flow diagrams of FIGS. 6-9, other methods of implementing the methods of FIGS. 6-9 may be employed. For example, the order of execution of the blocks may be changed, and/or some of the blocks described may be changed, eliminated, sub-divided, or combined. Additionally, any or all of the example methods of FIGS. 6-9 may be performed sequentially and/or in parallel by, for example, separate processing threads, processors, devices, discrete logic, circuits, etc.

FIG. 6 illustrates a presentation method 600 that may be carried out by a presenter (e.g., the presenter 104 (FIG. 3)). Although the presentation method of FIG. 6 is described in connection with the presenter 104 of FIG. 1, this is merely one example description.

When operating to implement the presentation method 600, the presenter 104 gathers slide information (block 602), which may include receiving information from for example a source device (e.g., the source device 102). Alternatively or additionally, gathering the slide information may include recalling slide information from memory (e.g. the memory 306). The slide information may include information describing slides, their order, and their content. For example, as shown in FIG. 1, the slides 108 and 112 may be slides including graphics and/or text, but not including animations. By contrast, the slide 110 may include animations represented by frames of animation information.

The slide information gathered by the presenter 104 may include one or more compressed images, graphics, etc. Thus, to create the slides from the gathered information, the presenter 104 will decompress any images (block 604). The decompression may be JPEG decompression or any other suitable image decompression corresponding to the techniques used to compress the image(s).

The presenter 104 assembles the slide information and the decompressed images to generate a slide frame set (block 606) and adds the images to the frames of the frame set (block 608). For example, if a slide (e.g., the slide 110 of FIG. 1) includes animation, the frame set includes the six frames (e.g., the frames 120, 122, 124, 126, 128, and 130) that are used to generate the animation. The images, such as the circle 140 are added to the frames.

The presenter 104 then processes the frames of the frame set to determine affected regions of each frame set (block 610). For example, the presenter 104 may evaluate consecutive frames to determine the changes that need to be made to the first frame to produce a second frame. Alternatively, the presenter 104 may evaluate the changes that need to be made between non-consecutive frames. For example, the presenter 104 may determine the changes that need to be made to frame one to make frame three, and the changes that need to be made to frame two to make frame four. Thus, consecutive or alternative frames may be evaluated. Of course, other techniques or frame differences may be used.

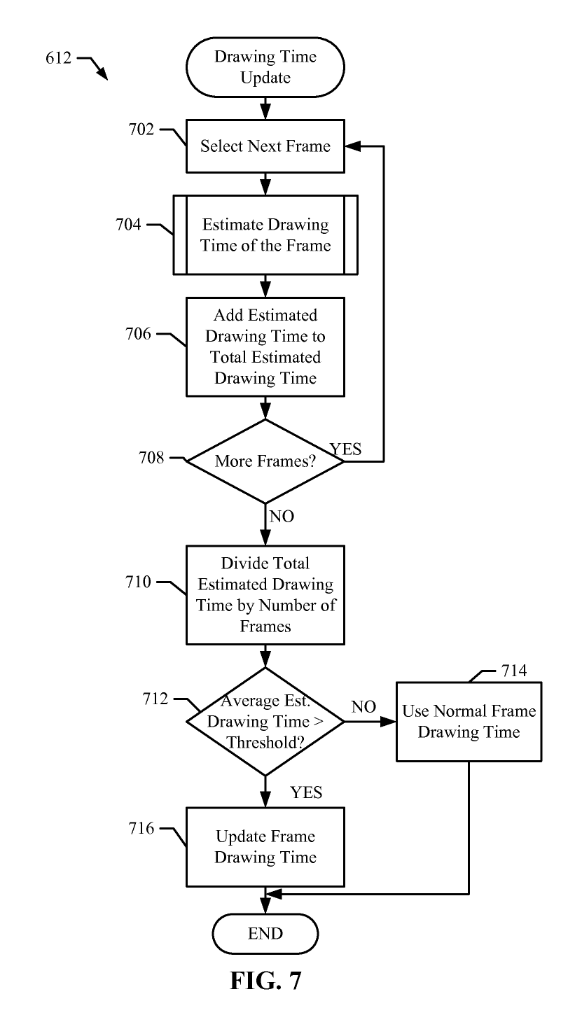

While an assumed drawing time may exist for each frame (e.g., 50 ms), drawing particular frames of the frame set may exceed the assumed frame time. Thus, the presenter 104 may determine a draw time that is different from the assumed draw time and may use that updated draw time for the frame set (block 612). In one example, the draw time that is determined may be used for each frame in the frame set. However, the draw time may be used for less than the entire frame set 119. Further detail regarding the determination of the updated draw time is provided below in conjunction with FIG. 7.

The next frame is then processed by the presenter 104 and displayed (block 614). It is determined if the frame is a draw frame, which is a frame that is part of an animation that needs to be drawn (block 616). If the frame is not a draw frame it is a frame representing a slide (e.g., the slide 108 or 112) and that frame is presented until it is time to transition from that slide or until a traversal command (e.g., a command from a user is received to advance the slide) is received (block 618).

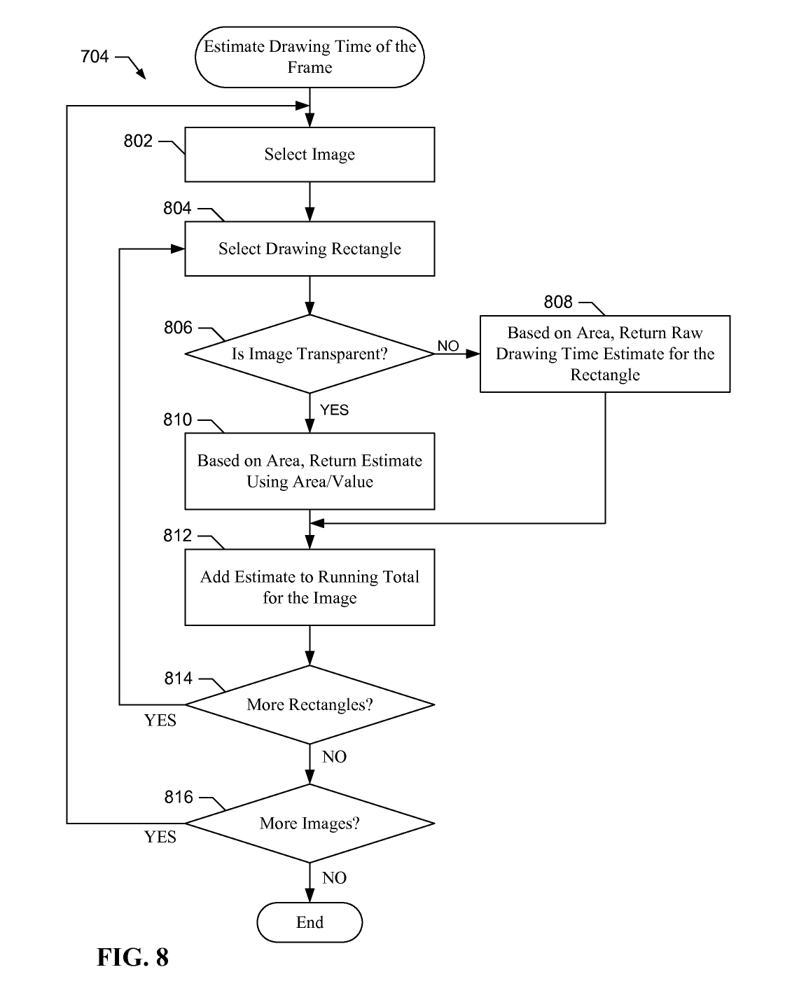

If, however, the frame is a draw frame (block 616) the frame is built (block 620) and presented. As described in FIGS. 8 and/or 10, the building and presentation may take advantage of the affected regions determined by the presenter 104 (block 610). As long as more frames are available (block 622) the method of FIG. 6 will iterate (i.e. control returns to block 616 for each additional frame).

FIG. 7 illustrates one example of a drawing time update method 612, which is carried out by the presenter 104 (FIG. 3). According to the example method 612, the presenter 104 selects a frame (block 702) and estimates the drawing time of the frame (block 704). For example, as explained above, the presenter 104 may use different assumptions or calculations to determine an estimate of the frame drawing time based on, for example, image transparency, image size, image type, drawing frame, drawing type, etc. For example, it may be determined that a frame having a significant amount of graphics (e.g., frame 124 of FIG. 1) may require 150 ms of drawing time, which is well above the assumed 50 ms of drawing time. Further detail regarding the drawing time estimate of a frame is provided below in connection with FIG. 8. The estimated drawing time is added to the total estimated drawing time of the frame set (e.g., the frame set 119 of FIG. 1) (block 706). This evaluation (i.e. blocks 702-706) is repeated until the last frame in the frame set is reached (e.g., the frame 130 of FIG. 1) (block 708).

The total estimated drawing time for the frame set is then divided by the total number of frames in the frame set (e.g., six for the frame set 119 of FIG. 1), to determine an average drawing time per frame (block 710). The average drawing time is then compared to a time threshold (block 712) and, if the average drawing time does not exceed the threshold, the normal frame time is used (e.g., 50 ms) (block 714). If, however, the average drawing time exceeds the threshold (block 712), the frame drawing time is updated from the assumed or normal frame drawing time to be the average frame drawing time (block 716). This slows down the animation to a frame time that accommodates the drawing of frames having drawing times exceeding the assumed drawing time. In one example, the threshold may be 50% longer than the assumed frame time (e.g., 75 ms). Of course, other measures than average frame draw time may be used.

FIG. 8 shows an example method 704 to estimate drawing time of a frame. The presenter 104 (FIG. 4) selects an image of the frame (block 802) and, within that image, selects a drawing rectangle (block 804). To determine the drawing time estimate for the rectangle, the presenter 104 determines if the image is transparent (block 806). If the image is not transparent (block 806), the presenter 104 determines based on area to be drawn, a drawing time estimate for the rectangle (block 808). In one example, drawing time estimates may be as follows:

| Image Size | Draw Time Estimate |
|---|---|
| 1024 × 768 pixels | 30 ms |
| Less than 980,000 pixels and greater | 25 ms |
| than 720,000 pixels | |
| Greater than 500,000 pixels and less | 20 ms |
| than 720,000 pixels | |

After the estimate is obtained (block 808), the estimate is added to a running total for the image (block 812).

Alternatively, if the image is not transparent (block 806), a drawing time estimate is based on the area to be drawn using, for example, the following relationship (block 810):

| Area | Time in ms |
|---|---|
| Less than 80,000 pixels | Number of pixels divided by 4000 |
| Between 80,000 pixels and 100,000 | Number of pixels divided by 5000 |
| pixels | |
| Between 100,000 pixels and 180,000 | Number of pixels divided by 6000 |
| pixels | |

This method is repeated for each rectangle (block 814) (i.e. control returns to block 804, for each additional rectangle) of each image (block 816) (i.e. control returns to block 802, for each additional image).

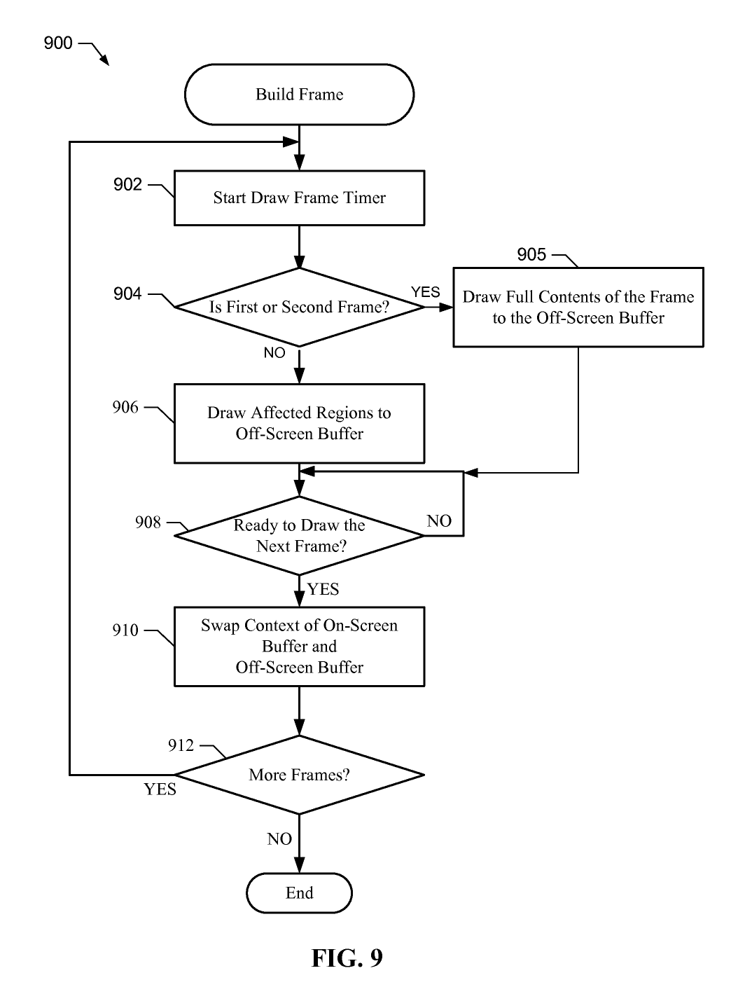

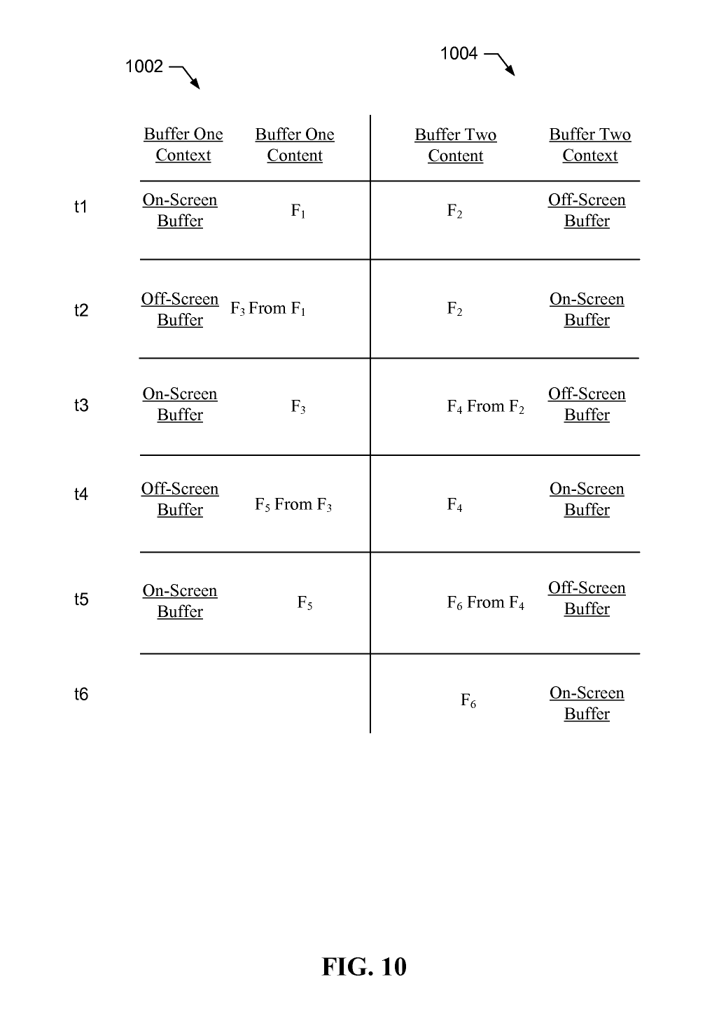

FIG. 9 illustrates a first example method 900 to build a frame. FIG. 9 is described in connection with FIG. 10. The method 900 may be carried out by the presenter 104, which starts the draw frame timer (block 902). The draw frame timer may be set to count down to or up to an assumed frame time of, for example, 50 ms. Alternatively, the frame timer may be updated as described above to be an average of the draw times of a frame set, or any other suitable time.

The presenter 104 then determines if the frame being processed is the first or second frame in the frame set (block 904). If so, the full contents of the frame are drawn to the off-screen buffer (e.g., the buffer having the context of being “off-screen”) (block 905). After the full contents are drawn (block 905), the presenter determines if it is time to draw the next frame (block 908) and, if so, the context of the on-screen buffer and the off-screen buffer are swapped (block 910), thereby displaying the content that was previously off-screen. The next frame is then selected (block 912).

After the first and second frames have been processed as above, the buffer status looks as shown in FIG. 10 at t1. FIG. 10 shows a column for buffer one 1002 and a column for buffer two 1004. Within each column are indications of buffer context and buffer content. Thus, as shown in FIG. 10 at t1, buffer one is on-screen and contains F1 and buffer two is off-screen and contains F2.

After the first and second frames have been processed (block 904), the presenter 104 draws affected regions to the off-screen buffer to produce a frame for future display (block 906). For example, as shown in FIG. 10, at t2, the changes to frame one to make frame three are applied to frame one in the off-screen buffer, while frame two is displayed in the on-screen buffer. Thus, when it is time to draw the next frame (block 908), and the contexts are swapped (block 910), as shown at t3 buffer one becomes the on-screen buffer to display frame three and buffer two will be updated to make frame four from frame two. This method repeats until all frames are drawn and presented as shown in FIGS. 9 and 10 at times t1-t6.

It is noted that this patent claims priority to U.S. Provisional Application Ser. No. 61/364,382, which was filed on Jul. 14, 2010, and is hereby incorporated herein by reference in its entirety.

Although certain example methods, apparatus and articles of manufacture have been described herein, the scope of coverage of this disclosure is not limited thereto.

What is claimed is:

1. A method comprising:
writing a first frame of information into a first buffer;
writing a second frame of information into a second buffer;
displaying the first frame of information;
displaying the second frame of information; and
updating the first buffer using a difference between the first frame of information and a third frame of information.

2. A method as defined in claim 1, further comprising determining the difference between the first frame of information and the third frame of information.

3. A method as defined in claim 2, wherein determining the difference occurs prior to writing the first frame of information into the first buffer.

4. A method as defined in claim 1, further comprising:
displaying the third frame of information; and
updating the second buffer using a second difference between the second frame of information and a fourth frame of information while the third frame of information is displayed.

5. A method as defined in claim 1, further comprising receiving drawing information, wherein writing the first, second, and third frames of information is based on the drawing information.

6. A method as defined in claim 1, further comprising receiving a frame draw time, wherein displaying the second frame of information is based on the frame draw time.

7. A method as defined in claim 1, wherein updating the first buffer occurs while the second frame of information is displayed.

8. A method as defined in claim 1, wherein displaying the second frame of information is temporally disposed between display of the first frame of information and display of the third frame of information.

9. An apparatus comprising:
a first buffer and a second buffer;
an output selector to select one of the first buffer or the second buffer; and
a buffer manager to:
write a first frame of information into the first buffer;
write a second frame of information into the second buffer;
control the output selector to select the first buffer for display of the first frame of information;
control the output selector to select the second buffer for display of the second frame of information;
update the first buffer using a difference between the first frame of information and a third frame of information; and
control the output selector to select the first buffer for display of the third frame of information.

10. An apparatus as defined in claim 9, wherein the buffer manager is to update one of the first buffer or the second buffer in an off-screen context while the other of the first buffer or the second buffer are in an on-screen context.

11. An apparatus as defined in claim 9, wherein the buffer manager is to receive drawing information and is to write the first, second, and third frames of information based on the drawing information.

12. An apparatus as defined in claim 11, wherein the drawing information comprises an animation.

13. An apparatus as defined in claim 9, wherein the first frame of information and the second frame of information are full frames of information, and the difference between the first frame of information and the third frame of information is less than a full frame of information.

14. An apparatus as defined in claim 9, further comprising a draw timer to receive a frame draw time, the buffer manager to control the output selector to select the first buffer or the second buffer based on the frame draw time.

15. A presenter, comprising:
a slide processor to generate drawing information based on an animation; and
a slide drawer to:
write a first frame of information to a first buffer;
write a second frame of information to a second buffer;
alternate the first buffer and the second buffer between an on-screen context and an off-screen context, the first and second buffers to be in different ones of the contexts at a given time; and
update the first buffer using a difference between a third frame of information in the first buffer that is different than a fourth frame of information in the second buffer and a fifth frame of information, the slide drawer to update the first buffer when the first buffer is in the off-screen context and the second buffer is in the on-screen context.

16. A presenter as defined in claim 15, wherein the first, second, third, fourth, and fifth frames of information are based on the drawing information.

17. A presenter as defined in claim 15, wherein the slide drawer is to update the second buffer using a second difference between the fourth frame of information in the second buffer and a sixth frame of information, the slide drawer to update the second buffer when the second buffer is in the off-screen context and the first buffer is in the on-screen context.

18. A presenter as defined in claim 15, wherein the first frame of information and the second frame of information are full frames of information.

19. A presenter as defined in claim 15, wherein the slide processor comprises a frame set generator to generate a frame set corresponding to the animation, the frame set comprising the first and second frames of information.

20. A presenter as defined in claim 19, wherein the slide processor is to receive slide information including a presentation slide and to determine whether the animation is in the presentation slide.
